(19) United States
(12) Patent Application Publication
(10) Pub. No.: US 2011/0192863 A1
(43) Pub. Date: Aug. 11, 2011

(54) Ingestible Tablet Dispensers And Methods Of Dispensing Tablets

(76) Inventors: Paul Leslie Barrass, Camberley (GB); Paul Alfred Cimiluca, Cincinnati, OH (US)

(21) Appl. No.: 12/972,635

(22) Filed: Dec. 20, 2010

Related U.S. Application Data
(60) Provisional application No. 61/291,500, filed on Dec. 31, 2009.

(51) Int. Cl. B65D 83/04; B65G 59/00; A23L 1/00

(52) U.S. Cl. 221/92; 221/282; 426/144; 426/89

(57) ABSTRACT

A portable tablet dispenser includes a plurality of cartridges including a first cartridge including a first plurality of ingestible tablets housed therein and a second cartridge including a second plurality of ingestible tablets housed therein. A main housing includes a first cartridge port that receives a dispensing end of the first cartridge and a second cartridge port that receives a dispensing end of the second cartridge. A dispensing mechanism is located in the main housing. The dispensing mechanism is configured to selectively dispense an individual ingestible tablet from one and simultaneously both of the first cartridge and the second cartridge where selection is based on a user input.

### CROSS REFERENCE TO RELATED APPLICATIONS

This application claims priority to U.S. Provisional Application No. 61,291,500, filed on Dec. 31, 2009.

### FIELD OF THE INVENTION

The present invention is generally directed to systems and methods for dispensing ingestible tablets.

### BACKGROUND

Increasingly, many consumers are finding themselves ingesting any number of different supplements throughout the day for a variety of reasons. Typically, the consumers manually retrieve the supplement tablets or capsules from their individual packaging and may ingest one or more of the supplement tablets immediately, or may hold onto one or more of the supplement tablets for a later time, for example in a different container. As another example, consumers may meter out their different supplements from individual packaging into individual containers, e.g., one container including all of their supplements for a particular day of the week.

Automated medicine handling systems are known. The automated systems are typically for industrial purposes and include relatively complex robotic mechanisms. What is needed is a portable, personal dispenser capable of dispensing multiple, different types of ingestible tablets that can be readily accessed by a consumer.

### SUMMARY

In one embodiment, an ingestible tablet includes a front face, a rear face and sides that extend about a periphery of the front and rear faces. A glidant coating may be provided and a groove extends along at least one of the front and rear faces. The groove intersects the periphery at opposite sides and being sized to receive a guide rail of a cartridge for inhibiting rotational movement and maintaining alignment of the ingestible tablet as the ingestible tablet is fed through the cartridge. The groove may have a glidant coating located therein thereby forming a recessed, low friction surface arranged to contact the guide rail of the cartridge.

In another embodiment, a cartridge for holding a plurality of ingestible tablets for a tablet dispenser is provided. The cartridge includes a front wall, a rear wall and side walls extending from the front wall to the rear wall. The front wall, rear wall and sidewalls define a volume for receiving the plurality of ingestible tablets such that the plurality of ingestible tablets may be fed from the volume. A guide rail extends into the volume along a height of the front wall or the rear wall. The guide rail is sized and arranged to slidably engage the plurality of ingestible tablets for inhibiting rotational movement and maintaining alignment of the plurality of ingestible tablets as the plurality of ingestible tablets are fed through the volume.

In another embodiment, a portable tablet dispenser includes a cartridge defining a volume for receiving a plurality of ingestible tablets. The cartridge includes a dispensing end through which the plurality of ingestible tablets are dispensed from the volume and a catch mechanism having a closed configuration that inhibits dispensing of the plurality of ingestible tablets from the volume and an open configuration that allows dispensing of the plurality of ingestible tablets from the volume. A main housing includes a cartridge port that receives the dispensing end of the cartridge. The main housing includes a catch engaging structure arranged and configured to engage the catch mechanism of the cartridge for moving the catch mechanism from the closed configuration to the open configuration.

In another embodiment, a portable tablet dispenser includes a carrier layer including a tablet carrying chamber sized to receive an ingestible tablet. A drop layer is located beneath the carrier layer and includes a tablet receiving opening through which the tablet may pass from the tablet carrying chamber. In a rest configuration, the tablet carrying chamber is in alignment with the tablet receiving opening. In a triggered configuration, the tablet carrying chamber is moved out of alignment with the tablet receiving opening.

In another embodiment, a portable tablet dispenser includes a plurality of cartridges including a first cartridge including a first plurality of ingestible tablets housed therein and a second cartridge including a second plurality of ingestible tablets housed therein. A main housing includes a first cartridge port that receives a dispensing end of the first cartridge and a second cartridge port that receives a dispensing end of the second cartridge. A dispensing mechanism is located in the main housing. The dispensing mechanism is configured to selectively dispense an individual ingestible tablet from one and simultaneously both of the first cartridge and the second cartridge where selection is based on a user input.

### BRIEF DESCRIPTION OF THE DRAWINGS

The following detailed description of specific embodiments of the present invention can be best understood when read in conjunction with the drawings enclosed herewith.

FIG. 1 is a side view of an embodiment of a tablet dispenser;

FIG. 2 is a perspective view of the tablet dispenser of FIG. 1;

FIG. 3 is a top view of an embodiment of a tablet for use with the tablet dispenser of FIG. 1;

FIG. 4 is a side view of the tablet of FIG. 3;

FIG. 5 is a section view of along line 5-5 of FIG. 3;

FIG. 6 is a front view of an embodiment of a cartridge for use with the tablet dispenser of FIG. 1;

FIG. 7 is an end view of the cartridge of FIG. 6;

FIG. 8 is a side view of the cartridge of FIG. 6;

FIG. 9 is another end view of the cartridge of FIG. 6;

FIG. 10 is a section view along line 10-10 of FIG. 6;

FIG. 11 is another view of the tablet dispenser of FIG. 1 having some of the cartridges removed;

FIG. 12 is a perspective view of the tablet dispenser of FIG. 11;

FIG. 13 is a perspective view of an embodiment of a body for use with a cartridge receiving housing for the tablet dispenser of FIG. 11;

FIG. 14 is a perspective view of an embodiment of a liner for use with a cartridge receiving housing for the tablet dispenser of FIG. 11;

FIG. 15 is a perspective view of an embodiment of a button shroud for use with a cartridge receiving housing for the tablet dispenser of FIG. 11;

FIG. 16 is a perspective view of an embodiment of a button for use with the button shroud and liner of FIGS. 14 and 15;

FIG. 17 illustrates an assembly of the button, button shroud, liner and a push rod according to one or more embodiments as shown and described herein;

FIG. 18 is a perspective view of an embodiment of a main housing for use with the tablet dispenser of FIG. 11;

FIG. 19 illustrates an embodiment of a top switch housing layer for use with an embodiment of a dispensing mechanism;

FIG. 20 illustrates an embodiment of a bottom switch housing layer for use with an embodiment of a dispensing mechanism;

FIG. 21 illustrates, diagrammatically, interaction between the bottom switch housing layer and a dispensing end of the cartridge of FIG. 6;

FIG. 22 illustrates, diagrammatically, the bottom switch housing layer of FIG. 20 with latching mechanisms according to one or more embodiments as shown and described herein;

FIG. 23 illustrates a perspective view of an embodiment of a carrier layer for use with an embodiment of a dispensing system;

FIG. 24 illustrates an embodiment of a push rod slot for use with the carrier layer of FIG. 23;

FIG. 25 illustrates a partial view of an embodiment of a push rod for moving the carrier layer of FIG. 23;

FIG. 26 illustrates an end view of the push rod of FIG. 25;

FIG. 27 illustrates the push rod of FIG. 25 inserted into the slot of FIG. 24;

FIG. 28 illustrates the push rod of FIG. 25 in an initial, undeflected position according to one or more embodiments as shown and described herein;

FIG. 29 illustrates the push rod of FIG. 25 in a deflected position according to one or more embodiments as shown and described herein;

FIG. 30 illustrates an embodiment of a drop layer for use with an embodiment of a dispensing mechanism;

FIGS. 31-33A illustrate interaction between the bottom switch housing layer of FIG. 20, the carrier layer of FIG. 23 and the drop layer of FIG. 30 according to one or more embodiments as shown and described herein;

FIG. 34 illustrates an embodiment of a removable container for holding dispensed tablets;

FIG. 35 illustrates an embodiment of a lid for use with the removable container of FIG. 34;

FIG. 36 is a side view of an embodiment of a tablet dispenser;

FIG. 37 diagrammatically illustrates another embodiment of a cartridge;

FIG. 38 diagrammatically illustrates another embodiment of an automated tablet dispenser; and

FIG. 39 diagrammatically illustrates another embodiment of a tablet dispenser.

The embodiments set forth in the drawings are illustrative in nature and not intended to be limiting of the invention defined by the claims. Moreover, individual features of the drawings and invention will be more fully apparent and understood in view of the detailed description.

### DETAILED DESCRIPTION

The following text sets forth a broad description of numerous different embodiments of the present invention. The description is to be construed as exemplary only and does not describe every possible embodiment since describing every possible embodiment would be impractical, if not impossible, and it will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims. All publications and patents cited herein are incorporated herein by reference.

It should also be understood that, unless a term is expressly defined in this specification using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). No term is intended to be essential to the present invention unless so stated. To the extent that any term recited in the claims at the end of this patent is referred to in this patent in a manner consistent with a single meaning, that is done for sake of clarity only so as to not confuse the reader, and it is not intended that such a claim term be limited, by implication or otherwise, to that single meaning Finally, unless a claim element is defined by reciting the word “means” and a function without the recital of any structure, it is not intended that the scope of any claim element be interpreted based on the application of 35 U.S.C. §112, sixth paragraph.

As used herein, the term “tablet” refers to a small ingestible mass including a supplement material. The term “supplement material” includes materials commonly referred to as vitamins and supplements and is not meant to exclude medicated materials. Tablets often include a mixture of a supplement material and excipients, often in powder form, pressed and/or compacted into a solid. Exemplary excipients may include binders, disintegrants to promote tablet break-up in the digestive tract; sweeteners or flavors to enhance taste; and/or pigments to make the tablets visually attractive. Coatings such as glidants and lubricants may be provided to promote efficient tabletting. Glidant coatings may refer to any coating which can be used to lower the frictional force of a tablet against a surface. Polymer coatings (which may be a form of glidant coating) may be provided to make the tablet smoother and easier to swallow, to control the release rate of the supplement material, to make the tablet more resistant to the environment and/or to enhance the tablet's appearance.

As used herein, the term “portable” refers to the capability of being carried by hand from one location to another. In some embodiments, a portable device weights about 25 pounds or less, such as about 10 pounds or less, such as about 5 pounds or less and has a dimension (e.g., height and/or width) of no greater than about three feet or less, such as two feet or less, such as one foot or less, such as about 10 inches or less, such as about five inches or less.

I. Introduction

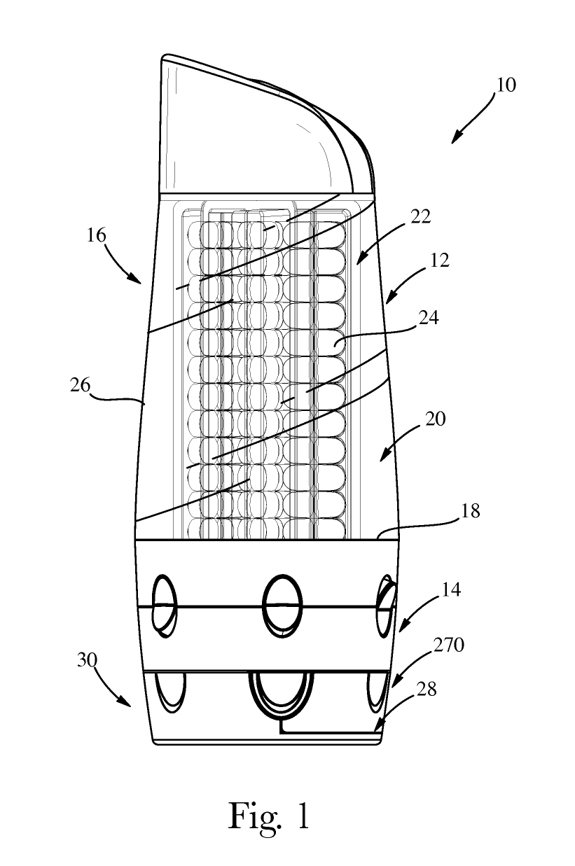

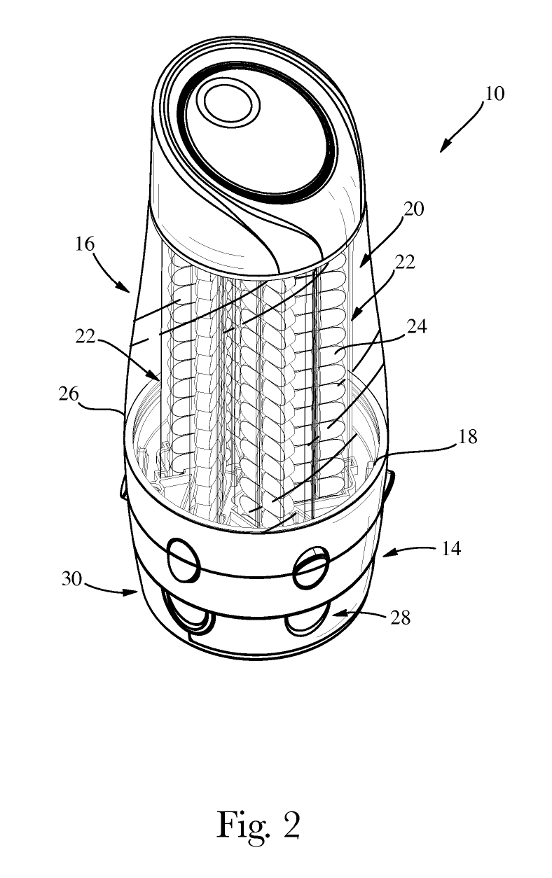

Referring to FIGS. 1 and 2, a portable, ingestible tablet dispenser 10 generally includes an outer casing 12 formed by a lower, main housing 14 and an upper, cartridge receiving housing 16. The upper, cartridge receiving housing 16 may releasably mate with the lower, main housing 14 at a connection location 18 provided between the upper, cartridge receiving housing 16 and the lower, main housing 14. A volume 20 is provided between the upper, cartridge receiving housing 16 and the lower, main housing 14 that is sized to receive one or more cartridges 22 containing one or more ingestible tablets 24. As can be seen by FIGS. 1 and 2, the upper, cartridge receiving housing 16 may include a body 26 formed, for example, of a transparent or translucent material such that the cartridges 22 can be viewed from outside the tablet dispenser 10. In other embodiments, the body 26 may be formed of an opaque material and/or the body 26 may have one or more designs covering the surface thereof. In some embodiments, one or more of the cartridges 22 may also be formed of a transparent or translucent material such that the tablets 24 can be viewed from outside the cartridges 22 and from outside the tablet dispenser 10. In other embodiments, the cartridges 22 may be formed of an opaque material and/or have one or more designs covering the surface thereof. As will be described in greater detail below, the tablet dispenser 10 allows for selective dispensing of one or more tablets simultaneously from one or more of the cartridges 22 based on user input. In other words, a user may select which of the tablets (or cartridges) are desired to be dispensed (or dispensed from) and the tablet dispenser may simultaneously dispense only those tablets that are selected. In the illustrated embodiment, a drawer or removable container 28 may be provided at a base 30 of the tablet dispenser 10 for receiving the dispensed tablets 24. The removable container 28 may have a closed position, as illustrated by FIGS. 1 and 2 and an open and/or removed position for accessing the dispensed tablets 24. Each of the tablets 24, cartridges 22 and tablet dispenser 10 will be described below.

II. Tablets

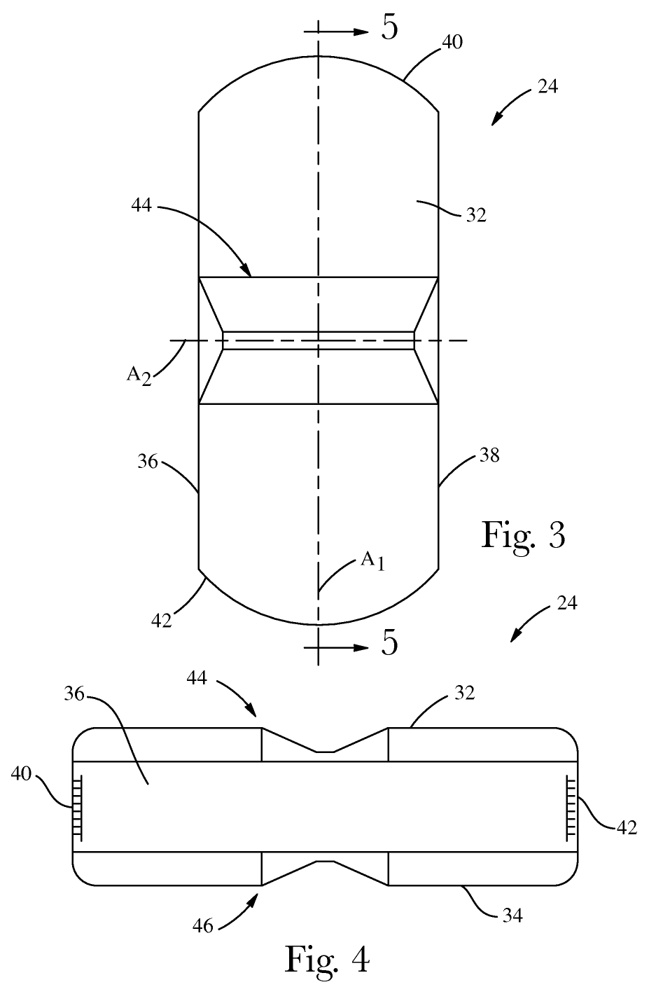

FIGS. 3 and 4 show an exemplary tablet 24 in isolation. The tablet 24 may generally include a front face 32, a rear face 34 opposite the front face 32 and sides 36, 38, 40 and 42 that extend about the periphery of the front face 32 and the rear face 34. In some embodiments, the tablet 24 may be somewhat oval in shape (e.g., having a longer major axis A₁ extending along a length of the tablet and a shorter minor axis A₂ extending along a width of the tablet), however, other shapes are contemplated.

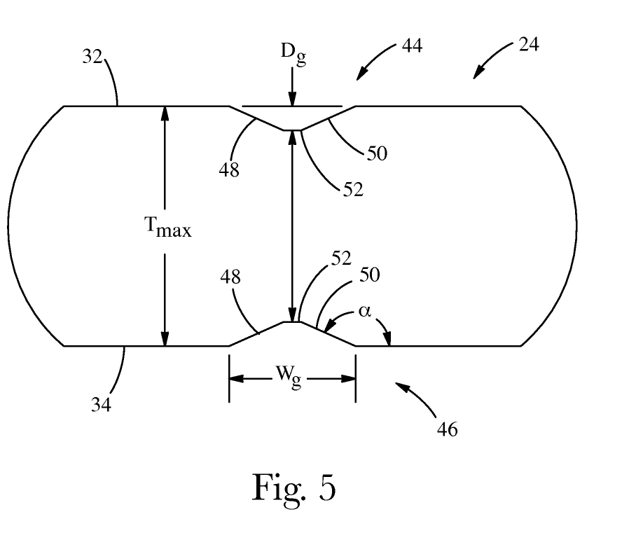

Referring to FIG. 5, the tablet 24 may include grooves 44 and 46 on one or both of the front and rear faces 32 and 34. In the illustrated embodiment, the grooves 44 and 46 are provided on a respective one of the front face 32 and the rear face 34. Each groove 44 and 46 may extend substantially parallel with the minor axis A₂ (and/or major axis A₁), which extends through a geometrical center of the tablet 24. In other embodiments, one or more grooves may be provided that are offset from the minor axis A₂ (and/or major axis A₁). The grooves 44 and 46 may also intersect opposite sides, e.g., sides 38 and 42 (and/or sides 36 and 40).

In the illustrated embodiment, the grooves 44 and 46 may include a cross-sectional width W_{g} and a depth D_{g}. The width W_{g} may be defined as the maximum distance between sidewalls 48 and 50 of the grooves 44 and 46 along the length of the grooves 44 and 46 and the depth D_{g} may be defined as the maximum depth from the respective face 32 and 34 to a base 52 of the grooves 44 and 46. In some embodiments, the ratio of the width W_{g} to the depth D_{g} is no greater than about 2.5. In some embodiments, the sidewalls 48 and 50 of the grooves 44 and 46 may be slanted inwardly toward each other, forming somewhat V-shaped grooves 44 and 46 that extend inwardly to the base 52. In these embodiments, outer edges 54 and 56 of the sidewalls 48 and 50 may form an angle a that is greater than 90 degrees (e.g., between about 90 degrees and about 150 degrees) with the respective face 32 and 34. In other embodiments, the sidewalls 48 and 50 may be relatively straight with a being about 90 degrees.

The tablets 24 may have a minimum thickness Tₘᵢₙ, e.g., at the one or more grooves 44 and 46 and a maximum thickness Tₘₐₓ, e.g., adjacent the one or more grooves 44 and 46. In some embodiments, the minimum thickness Tₘᵢₙ is no greater than about 95 percent of the maximum thickness Tₘₐₓ. In some embodiments, the minimum thickness Tₘᵢₙ is no less than about 50 percent of the maximum thickness Tₘₐₓ.

The tablets 24 may be formed of a mixture of a supplement material and excipients, in powder form, pressed and/or compacted into a solid. The tablets 24 may include, for example, any one or more of the following: antioxidants (e.g., pomegranate, green tea, vitamins A, C and E, anthocyanidins, catechins, epicatechins, flavanols, flavonoids, free radicals, lutein, lycopene, phenols, proanthocyanidins, procyanidins, zeaxanthin); immune-enhancing ingredients (e.g., black seed, ginseng, probiotics, arabinogalactan, arginine, astragalus, amaranth oil, black currant, colostrum, cat's claw, echinacea, gamma linolenic acid, goldenseal, maitake mushroom, rose hip, shiitake, taurine, thymus extract, vitamins B6, D and E); omega-3 sources (e.g., flax seed, fish oils, English walnuts, soybean oil, linseed oil, olive oil, borage seed oil, canola oil); energy enhancing ingredients (e.g., green tea, rhodiola, B vitamins, carnitine, creatine, ginkgo biloba, ginseng, guarana extracts, inositol, maltodextrin, taurine); stress-relief and mental health ingredients (e.g., SAMe (s-adenosyl-L-methionine), kava kava (piper methysticum), sage, St. John's Wort, valerian (valerian officinalis), 5-hydroxytryptophan (5-HTP), dehydroepiandoseterone (DHA), phenylalanine, melatonin, chamomile, creatine, L-theanine); and joint and bone health ingredients (e.g., glucosamine, calcium, chondroitin, willow bark, 5-HTP, avocado/soybean unsaponifiables, borage seed oil, chlorella, devil's claw, omega-3 fatty acids (see sources above), rose hip, SAMe, vitamin D).

In some embodiments, the tablets 24 may be coated with one or more coatings 60. For example, an enteric coating and a delayed release coating may be applied to the tablets 24. Examples of enteric coating materials include ethylcellulose, pectin, guar gum, methyl methacrylate and cellulose acetate phthalate. Examples of delayed release materials include ethylcellulose, methylcellulose, hydroxypropyl cellulose, hydroxypropyl methyl cellulose, pectin, guar gum and xanthan gum. Various other coating materials include methylmethacrylate, methacrylic acid copolymer, polyvinyl acetate phthalate, hydroxypropyl methylcellulose phthalate, hydroxypropyl methyl acetate succinate, cellulose acetate phthalate, polyethylene glycol, triethylacetate, glyceryl triacetate, acetyltriethylcitrate, dibutyl sebacate, dibutyl phthalate, glycerol, triacetin, acetylated monoglyceride, oleic acid and stearic acid. Coatings (e.g., glidant coatings) may be used for ease of swallowing. Flavors may also be added to the coatings, such as mint flavors, tart flavors, etc. Such flavors may provide benefits to the consumers, such as stomach relief and certain perception benefits such as reduced grittiness and tablet size.

The tablets 24 may be any of a variety of colors. In some embodiments, it may be desirable that tablets housed within a given cartridge 22 are of a certain color, while tablets within a different cartridge 22 are of a different color. This may be useful to associate certain colors of tablets 22 with certain functions; for example, a reddish-colored tablet 22 may be associated with heart health making it easier for the user to select the desired tablet 22 for dispensing. It will be well understood that tablets housed within a given cartridge 22 or within multiple cartridges 22, or within a tablet dispenser 10, may be of same or different colors. Selection of colors and manufacture of tablets of any given desired color are well within the capabilities of the ordinarily skilled artisan.

In some embodiments, the tablets 24 may include medicated materials such as decongestants and/or other medicated materials. Example decongestants include: oxymetazoline, phenylephrine, xylometazoline, naphazoline, 1-desoxyephedrine, ephedrine, propylhexedrine, pseudoephedrine, and phenylpropanolamine. Example anticholinergics include: ipratropium, chlorpheniramine, brompheniramine, diphenhydramine, doxylamine, clemastine, and triprolidine. Common analgesics, anti-inflammatories and antipyretics include: ibuprofen, ketoprofen, diclofenac, naproxen, acetaminophen, and aspirin. Example antivirals include: amantidine, rimantidine, pleconaril, zanamivir, and oseltamivir. Examples of antitussives include codeine, dextromethorphan, chlophedianol and levodropropizine. Examples of expectorants include guaifenesin. Examples of mucolytics include ambroxol and N-acetylcysteine. Examples of antihistamines include diphenhydramine, doxylamine, triprolidine, clemastine, pheniramine, chlorpheniramine, brompheniramine, loratadine, cetirizine and fexofenadine.

Compositions included in the tablets 24 can comprise a wide range of additional pharmaceutical actives. Nonlimiting examples include antitussives, antihistamines, non-sedating antihistamines, decongestants, expectorants, analgesics, antipyretic anti-inflammatory agents, local anesthetics, anti-inflammatory agents, demulcents, herbal remedies, vitamins, supplements, antioxidants, natural ingredients, minerals, energy boosting ingredients, sleep aids and immune system boosting, tea extract, antioxidant, amino acid, enzyme, prebiotic, probiotic, andrographis extract, 1-tryptophan, Allium sativum, anticholinergics, antivirals, mucolytics, and combinations thereof.

Examples of decongestants include: oxymetazoline, phenylephrine, xylometazoline, naphazoline, 1-desoxyephedrine, ephedrine, propylhexedrine, pseudoephedrine, and phenylpropanolamine. Examples of anticholinergics include: ipratropium, chlorpheniramine, brompheniramine, diphenhydramine, doxylamine, clemastine, and triprolidine. Common analgesics, anti-inflammatories and antipyretics include: ibuprofen, ketoprofen, diclofenac, naproxen, acetaminophen, and aspirin. Examples of antivirals include: amantidine, rimantidine, pleconaril, zanamivir, and oseltamivir. Examples of antitussives include codeine, dextromethorphan, chlophedianol and levodropropizine. Examples of expectorants include guaifenesin. Examples of mucolytics include ambroxol and N-acetylcysteine. Examples of antihistamines include diphenhydramine, doxylamine, triprolidine, clemastine, pheniramine, chlorpheniramine, brompheniramine, loratadine, cetirizine and fexofenadine.

Nonlimiting examples of additional pharmaceutical actives include but are not limited to, pyrilamine, promethazine, oxycodone, hydrocodone, carbinoxamine, caffeine, benzonatate, pheniramine, fentanyl, azatedine, desloratadine, carbamazepine, buprenorphine, hydromorphone, indomethacin, oxymorphone, phenol, codeine, mesalamine, dichlophenac, sulindac, beclomethaxone, meloxicam, fenoproten, mometasone, menthol, benzocaine, dipyridamole, methscopolamine, the free and the addition salt forms, chamomile, passion flower, Vitamin C, Vitamin D, B Vitamins, echinacea, melatonin, green tea, curcumin, zinc, selenium, calcium, guarana, probiotics and mixtures thereof.

The compositions may comprise an amount of at least one additional pharmaceutical active in the range of about zero (0) mg to about 1,000 mg of each of at least one additional pharmaceutical active, alternatively from about 2.5 mg to about 750 mg, and alternatively from about 5 mg to about 650 mg of each of at least one additional pharmaceutical active, all per dose of the composition.

The compositions may comprise an amount of additional pharmaceutical active in the range of about 0% to about 20%, alternatively 0.0001% to about 15%, alternatively from about 0.001% to about 10%, and alternatively from about 0.01% to about 5%, all by weight of the composition.

As indicated above, the composition can comprise an excipient. The composition can comprise from about 0.1% to about 99% of the excipient, by weight of the composition, alternatively from about 0.25% to about 70%, alternatively from about 0.5% to about 70%, alternatively from about 2% to about 70%, alternatively from about 3% to about 40%, alternatively from about 5% to about 30%, alternatively from about 6% to about 25% of the excipient, by weight of the composition. Nonlimiting examples of excipients include of microcrystalline cellulose, dicalcium phosphate, stearic acid, magnesium stearate, corn starch, lactose, sodium croscarmellose, sodium starch glycolate, polyvinylpyrollidone, gelatin and combinations thereof. When the excipient is magnesium stearate, the level of magnesium stearate present may be at least 0.1%, alternatively less than about 0.5%, alternatively less than about 0.25%, by weight of the composition. By keeping the level of magnesium stearate at least about 0.1%, aids to prevent darkening of the composition caused by the presence of certain sensitive ingredients such as doxylamine and/or phenylephrine.

The composition may comprise a chelating agent. Non-limiting examples of chelating agents include but are not limited to the salts of disodium and calcium salts of ethylene diamine tetraacetic acid (EDTA), tetrasodium EDTA, sodium hexametaphosphate (SHMP), citric acid, phosphoric acid, di(hydroxyethyl)glycine, 8-hydroxyquinoline, and mixtures thereof. Trivalent metal chelating agents such as galactomannans complexed with iron may also be useful. Wherein the compositions herein comprise a chelaing agent, the compositions may optionally comprise from about 0.0001% to about 1% of the chelating agent, alternatively from about 0.001% to about 0.5%, and alternatively from about 0.01% to about 0.3% of the chelating agent, all by weight of the composition.

The composition may comprise a sweetener to provide sweetness and aid in the taste masking of a pharmaceutical active(s) and/or sensitive ingredients. The sweeteners of the present invention can be artificial sweeteners and/or natural sweeteners. Non-limiting examples of artificial sweeteners are selected from the group consisting of sodium saccharine, acesulfame potassium, sucralose, aspartame, monoammonium glycyrrhizinate, neohesperidin dihydrochalcone, thaumatin, neotame, cyclamates, and mixtures thereof. Nonlimiting examples of natural sweeteners include sucrose, fructose, glucose, glycerin, sorbitol, maltitol, and mannitol and combinations thereof.

The compositions can comprise a wide range of optional ingredients. Nonlimiting examples of optional ingredients include antimicrobial metal salts, optional mildness enhancers, optional stabilizers, abrasives, antioxidants, biological additives, chemical additives, colorants, coolants, chelants, denaturants, drug astringents, emulsifiers, external analgesics, film formers, fragrance compounds, humectants, opacifying agents, plasticizers, preservatives, propellants, reducing agents, solvents, foam boosters, hydrotropes, solublizing agents, suspending agents (non-surfactant), a solvent, viscosity increasing agents (aqueous and non-aqueous), sequestrants, vitamins, antioxidants, buffers, keratolytics, and the like, and combinations thereof. The optional ingredient may be selected from the group consisting of solvents, a chelant, a preservative, a fragrance, buffer, antimicrobial metal salts and combinations thereof. Nonlimiting examples of antimicrobial metal salts include zinc, iron, copper, silver, tin, bismuth, and combinations thereof. Nonlimiting examples of preservatives include but are not limited to benzoalkonium chloride, EDTA, benzyl alcohol, potassium sorbate, parabens, and mixtures thereof.

Unless otherwise specified, the compositions may optionally comprise one or more given optional ingredients at concentrations ranging from about 0.001% to about 99%, alternatively from about 0.01% to about 80%, alternatively from about 0.01% to about 50%, alternatively from about 0.01% to about 10%, all by weight of the composition.

III. Cartridges

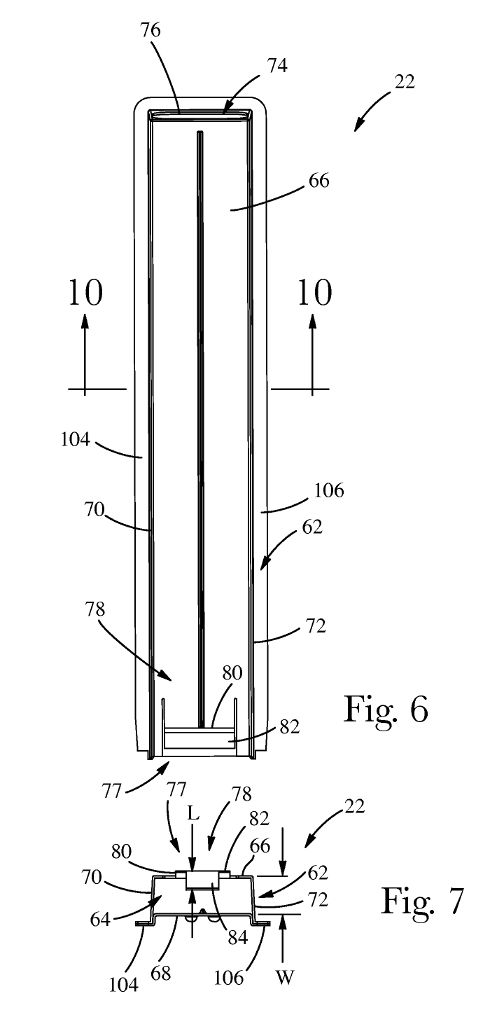

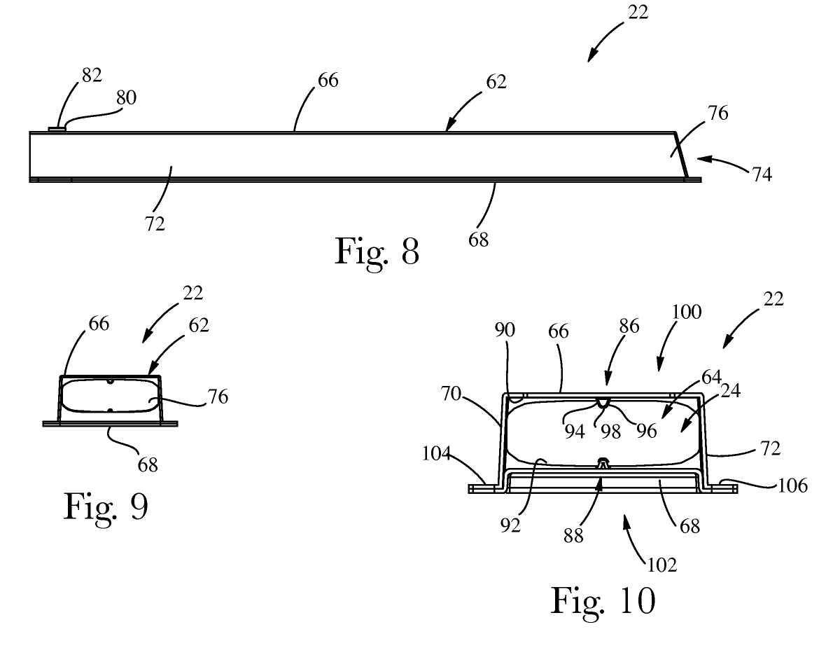

Referring to FIGS. 6-10, the cartridges 22 may generally include a housing portion 62 that provides a volume 64 for housing the tablets 24. The volume 64 may be formed between a front wall 66, a back wall 68 opposite the front wall 66 and side walls 70 and 72 that extend between the front wall 66 and back wall 68 forming a somewhat hexahedral-shaped volume 64 for housing the tablets 24. One end 74 of the cartridges 22 may be closed by an end wall 76 and an opposite, dispensing end 77 of the cartridges 22 may be at least partially open. In other embodiments, the end 74 may be open or at least partially open (e.g., for refilling the cartridges). Any of the front wall 66, back wall 68 and side walls 70 and 72 may include an opening for refilling the cartridge 22. As another example, a tablet sized opening may be provided in the sides 70, 72, front 66 and/or back 68 of the cartridge 22.

A catch structure 78 may be provided at the dispensing end 77. The catch structure 78 may include an outwardly extending portion 80 that extends outwardly, away from the volume 64 and a finger portion 82 that extends away from the outwardly extending portion 80. The outwardly extending portion 80 may provide a connection between the finger portion 82 and one or more of the front wall 66, back wall 68 and/or side walls 70 and 72. In the illustrated embodiment, the outwardly extending portion 80 cantilevers the catch structure 78 to the front wall 66. A catch member 84 may be located at an end of the finger portion 82 that extends into and/or beneath the volume 64. The catch member 84 may be sized and located to inhibit dispensing of tablets 24 by blocking at least a portion of the end 77. In some embodiments, the catch member 84 may extend into the volume 64 a length L that is at least about 10 percent of a width W of the volume 64 measured between the front wall 66 and the back wall 68. In some embodiments the length L may be at least about 20 percent of the width W. In some embodiments, the length L may be no more than about 80 percent of the width W, such as no more than about 50 percent of the width W. In some embodiments, the length L may be between about 5 percent and about 80 percent of the width W, such as between about 10 percent and about 50 percent of the width W.

Referring particularly to FIG. 10, the front wall 66 may include a guide rail 86 and/or the back wall 68 may include a guide rail 88. The guide rail 86 may generally be formed as an elongated protrusion that extends inwardly into the volume 64 from an internal surface 90 of the front wall 66, while the guide rail 88 may generally be formed as an elongated protrusion that extends inwardly into the volume 64 from an internal surface 92 of the back wall 68. The guide rails 86 and 88 may generally have a shape that conforms to the shape of the grooves 44 and 46 of the tablets 24. As can be seen by FIG. 10, the guide rails 86 and 88 may each include opposite portions 94 and 96 that extend generally toward each other from their respective internal surfaces 90 and 92 toward a peak 98. In some embodiments, the opposite portions 94 and 96 are shaped and arranged to engage the sidewalls 48 and 50 of the grooves 44 and 46. In some embodiments, each peak 98 may extend into the tablets 24 at least about five percent of the maximum thickness Tₘₐₓ of the tablets 24 and/or no more than about 50 percent of the maximum thickness Tₘₐₓ of the tablets 24. While the guide rails 86 and 88 are illustrated as being opposing, the guide rails may be offset from each other. Additionally, one or both of the front wall 66 and back wall 68 may include more than one or no guide rails.

The cartridges 22 may be formed using any suitable method or combination of methods such as molding and/or machining In some embodiments, the cartridges 22 are formed of a molding process where a first portion 100 including the front wall 66, sidewalls 70 and 72, end wall 76 and catch structure 78 is formed separately from a second portion 102 including the back wall 68. The first portion 100, once formed, may be attached to the second portion 102 at a flange portions 104 and 106 that extend along the periphery of the first portion 100 and the second portion 102, for example, using an adhesive, welding, etc. In some embodiments, the catch member 84 may be formed separately from the catch structure 78 and then attached thereto at the position illustrated by FIG. 6. As will be described in greater detail below, the catch structure may be formed of a flexible, resilient material providing a catch structure having a closed configuration that inhibits dispensing of the tablets 24 from the volume 64 and an open configuration that allows dispensing of the tablets 24 from the volume 64.

In some embodiments, one or more of the cartridges 22 may be filled with tablets 24 at a filling location that is remote from the consumer. The cartridges 22 may be sealed in packaging and then transported to the customer or to a retail location. In some embodiments, a foil or other temporary barrier may be placed over the open end of the cartridge 22 that can be removed by the consumer. In some embodiments, tamper evident packaging and/or features making the package difficult for young children to open may be provided. The cartridges 22 may be refillable and/or may be disposable. Any suitable materials may be used for forming the cartridges including food grade materials. Exemplary materials for forming the cartridge 22 may include, but not limited to, polyethylene terephalate (PET), polypropylene, polyethylene, polyvinylchloride, etc. The cartridge 22 may be opaque or transparent or a combination of opaque in some areas and transparent in others.

In some embodiments, the cartridges 22 may house tablets without grooves and or multiple columns of tablets. For example, round pills may be housed by the cartridges in some embodiments. In some embodiments, the cartridges 22 may be used to transport and dispense tablets 24 independently of the tablet dispenser 10.

The cartridges 22 may be transparent, opaque, or of any other appearance. In some embodiments, it may be desirable that at least one or all of the cartridges are transparent to some extent. For example, wherein tablets 22 housed within a given cartridge are of a certain color to associate a functional benefit as described herein above, some extent of transparency will be desirable such that the user can see the color of the tablets, thereby aiding a dispensing decision. It is well within the skills of the ordinary artisan to design and manufacture cartridges having the desired appearance.

III. Tablet Dispenser

Referring back to FIGS. 1 and 2, as indicated above, the tablet dispenser 10 includes the outer casing 12 formed by a lower, main housing 14 and upper, cartridge receiving housing 16 that may releasably mate (e.g., using a threaded connection) with the lower, main housing 14 at the connection location 18 provided between the upper, cartridge receiving housing 16 and the lower, main housing 14. The volume 20 is provided between the upper, cartridge receiving housing 16 and the lower, main housing 14 that is sized to receive one or more of the cartridges 22 containing one or more of the tablets 24.

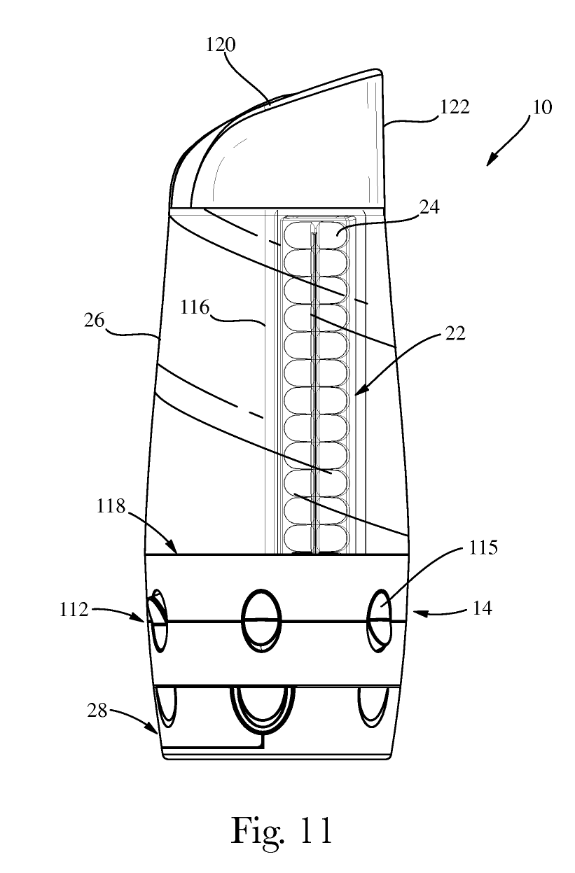

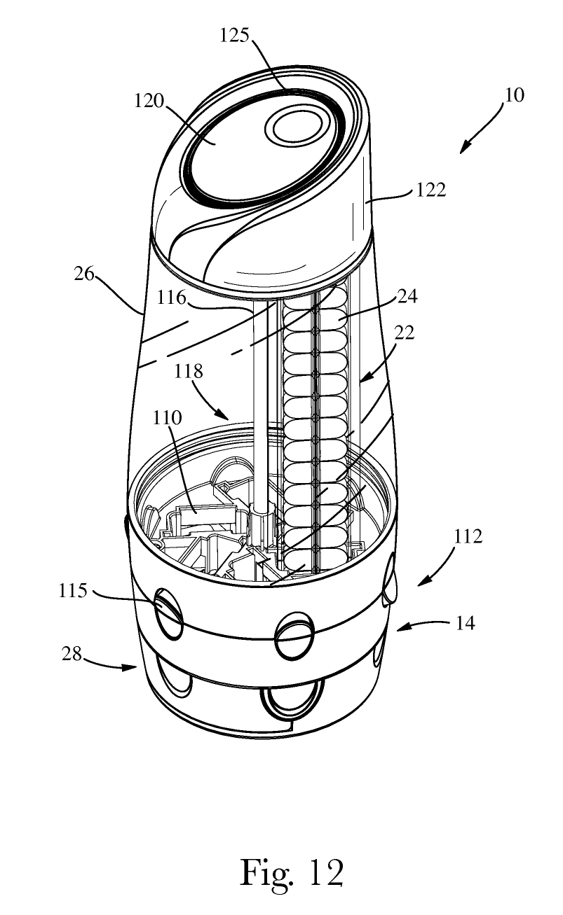

Referring now to FIGS. 11 and 12, the tablet dispenser 10 is illustrated with some of the cartridges 22 removed. The main housing 14 includes cartridge ports 110 that receive the dispensing ends 76 of the cartridges 22 such that the tablets 24 may be dispensed to the main housing 14 from the cartridges 22. Details of the main housing 14 are described below. A user selector input 112 (e.g., including switches 115) is provided at the main housing 14 for allowing a user to select individual (or multiple) cartridges 22 from which to dispense tablets 24. A push rod 116 may be provided for actuating a dispensing mechanism 118 located in the main housing 14. An actuator (e.g., button 120) may be provided for actuating the push rod 116 to dispense tablets 24 into the removable container 28.

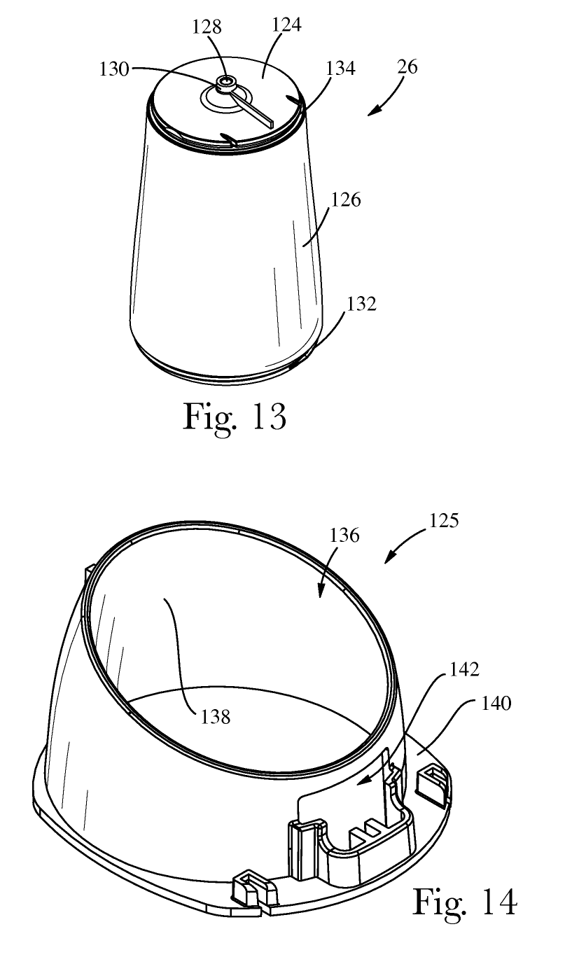

The upper housing 16 includes the body 26, a button housing 122 and a liner 125 where the button housing 122 and liner 125 are connected to the body 26. Referring to FIG. 13, the body 26 of the upper housing 16 is illustrated in isolation and includes a top 124 and a sidewall 126 extending downward from the top 124. In the illustrated embodiment, the body 26 is generally in the shape of a truncated cone, however, other shapes may be employed. A port 128 is provided in the top 124 that is sized to receive an end of the push rod 116 therethrough. A guide 130 is provided that extends upwardly from the top 124 to help stabilize and limit side-to-side movement of the push rod 116. The body 26 may also include a threaded portion 132 for connecting to the main housing 14. In some embodiments, an upper portion 134 may include a threaded surface or other connection for connecting the body 26 to the button holder 122.

Referring to FIG. 14, the liner 125 generally fits within the button housing 122 and is connected to the body 26. The liner 125 includes an opening 136 through which the button 120 may be depressed and released that is formed by a sidewall 138 that extends upwardly from a seating flange 140 against which the button housing 122 may seat. In some embodiments, the seating flange 140 may be shaped to be received within a bottom opening of the button housing 122. Pivot structure 142 is provided that pivotally mates with corresponding pivot structure carried by the button 120.

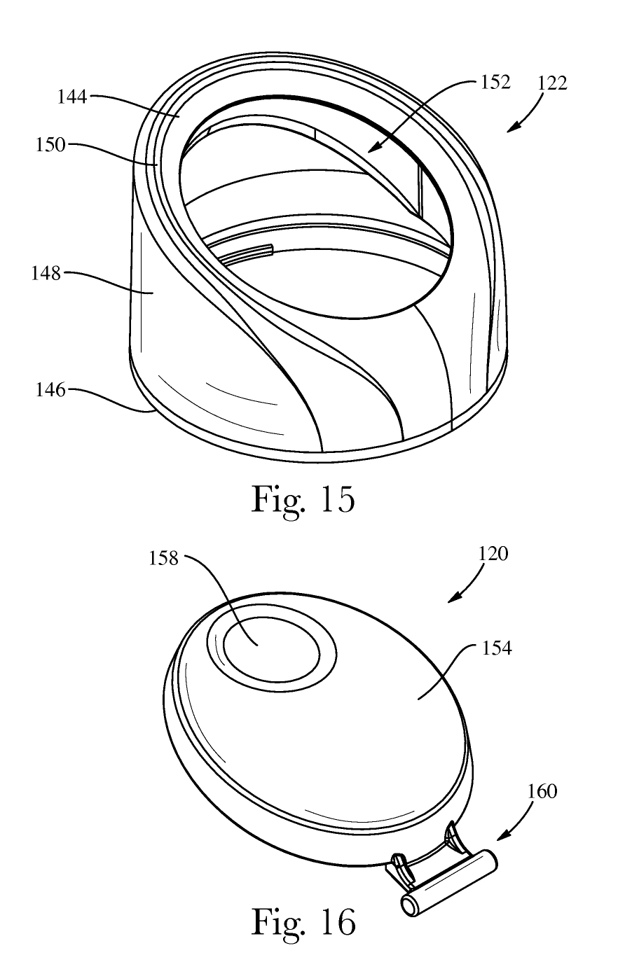

FIG. 15 illustrates the button housing 122 in isolation. The button housing 122 generally includes a top 144, a bottom 146 and a sidewall 148 extending from the bottom 146 to the top 144. The top 144 includes a lip 150 that extends into a button receiving opening 152. The button receiving opening 152 may also be sized to receive the sidewall 138 of the liner 125 thereby locating the pivot structure 142 of the liner 125 within the button housing 122. In other embodiments, the pivot structure 142 may be located outside the button housing 122.

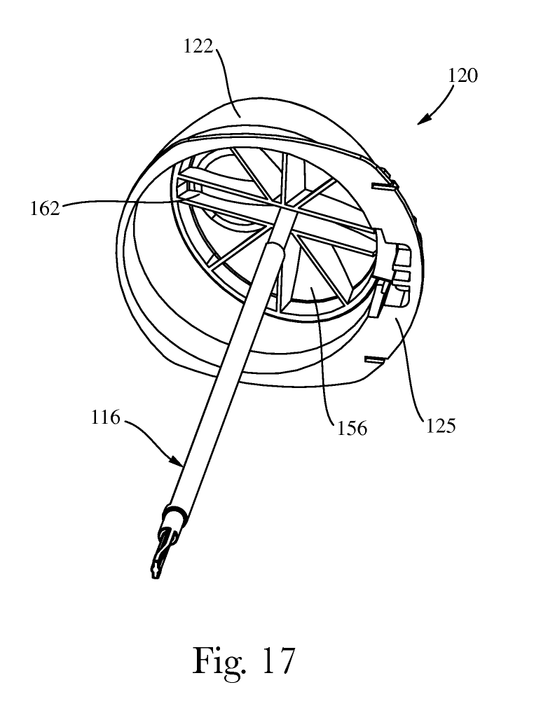

Referring to FIGS. 16 and 17, the button 120 is sized and shaped to fit within the openings 136 and 152 of the liner 125 and the button housing 122. In some embodiments, the sidewall 138 of the liner 125 is sandwiched between the button 120 and the button housing 122. The button 120 may be somewhat oval in shape and include an upper surface 154 and an opposite, lower surface 156. A finger placement feature (e.g., recess 158) may be provided to aid the user in finger placement for actuation of the button 120. Pivot structure 160 is provided at a rear of the button 120 that pivotally mates with the pivot structure 142 of the liner 125. A rod receiving feature 162 is provided along the lower surface 156 for receiving an end of the push rod 116. FIG. 17 illustrates the assembly of the button 120, liner 125, button housing 122 and push rod 116.

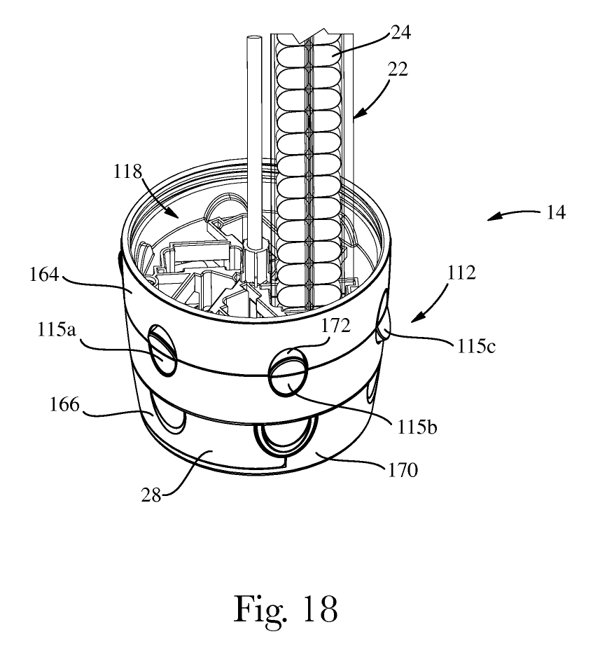

Referring to FIG. 18, the main housing 14 is shown with the cartridge receiving housing 16 removed and includes the dispensing mechanism 118 that allows for selective dispensing of one or more tablets simultaneously from one or more of the cartridges 22 based on user input. The main housing 14 may generally include an outer casing 164 and a container portion 166 beneath the outer casing 164. Selector switches 115 are provided about a periphery of the outer casing 164. Each selector switch 115 has an open configuration and a closed configuration (selector switches 115a and 115b are in the open configuration while selector switch 115c is in the closed configuration). In the open configuration, the selector switches 115 opens a latch mechanism (described below) that allows the tablets 24 to be dispensed from a cartridge 22 associated therewith. In the closed configuration, the selector switches 115 close the latch mechanism to prevent the tablets 24 from being dispensed from the cartridge 22 associated therewith. In some embodiments, the selector switches 115 may include an indicator for indicating when the selector switches 115 are in their open configurations. For example, a surface 172 of the selector switches 115 may be a color such as red to indicate when the selector switches 115 are in their open configurations. In another embodiment, a light, such as an LED may be activated when an associated selector switch 115 is in the open configuration. The container portion 166 may include the removable container 28 and a removable container receiving member 170 that is used to shelve the removable container 28 beneath the dispensing mechanism 118 within the outer casing 164.

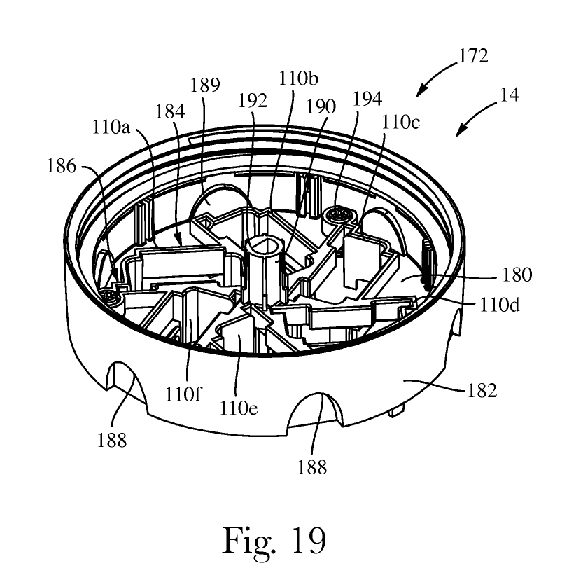

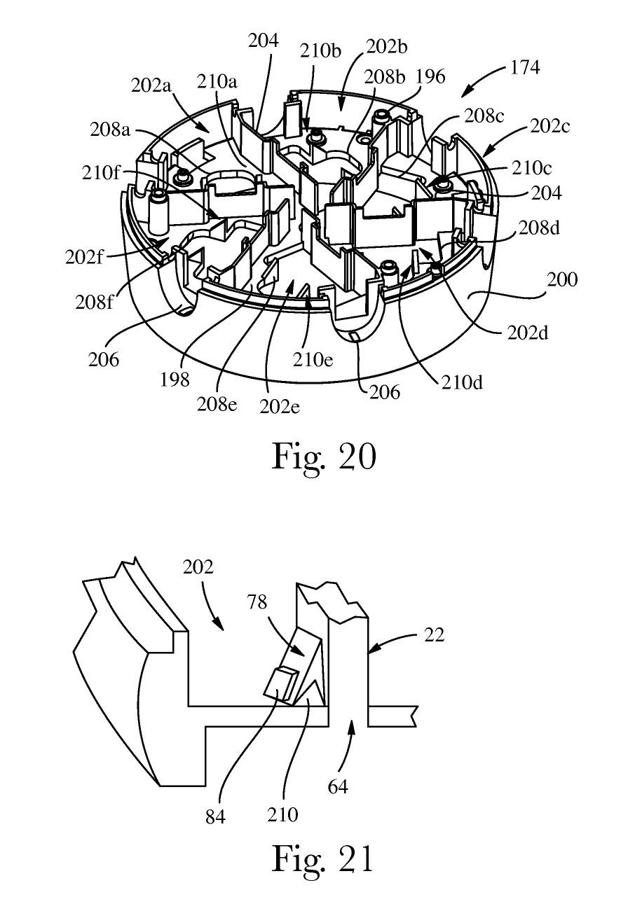

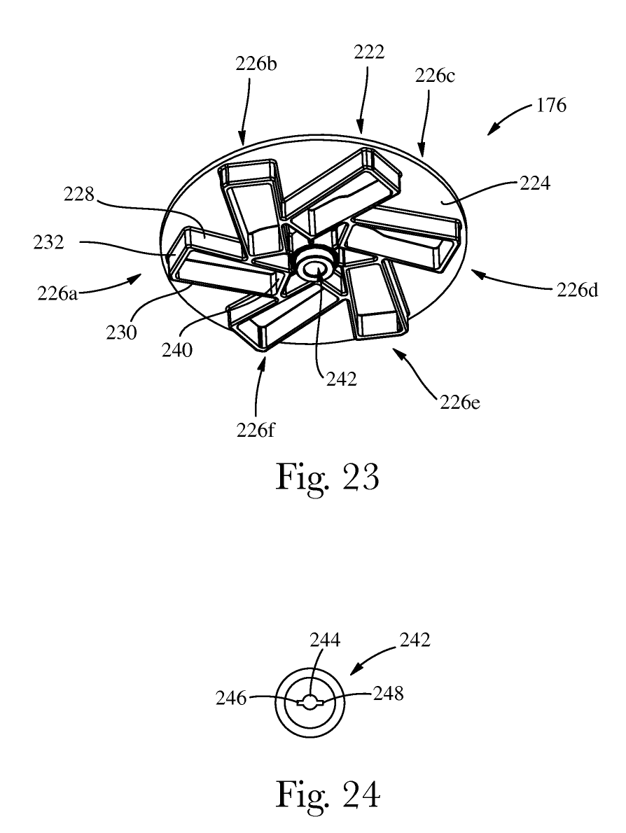

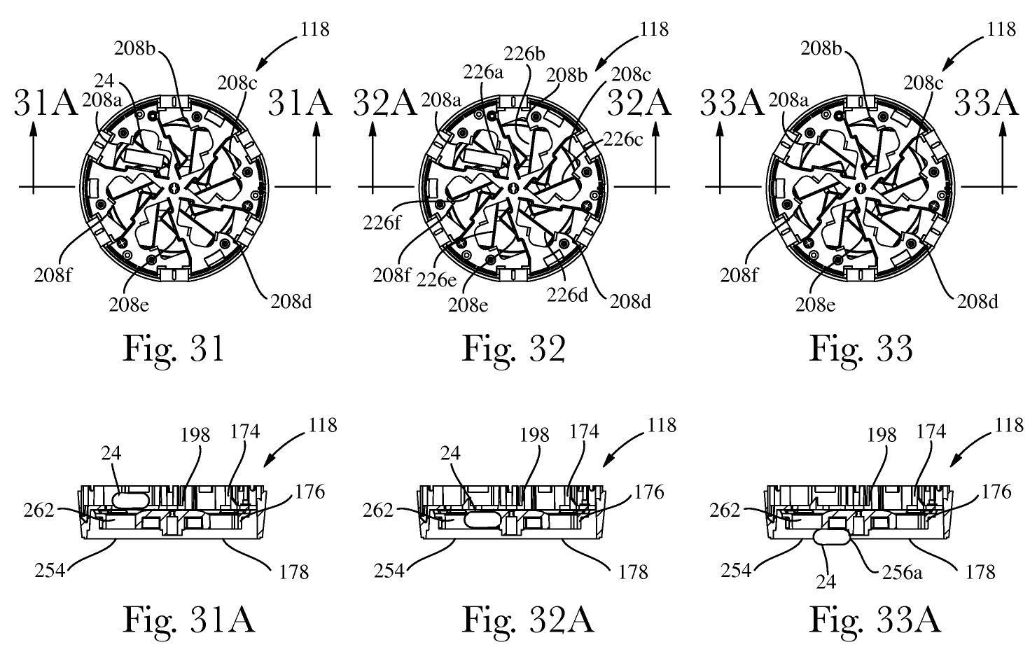

Referring to FIGS. 19-31, the dispensing mechanism 118 may be formed as part of the main housing 14 and may be a multi-layer mechanism including a top switch housing layer 172 (FIG. 19), a bottom switch housing layer 174 (FIG. 20), a carrier layer 176 (FIGS. 23 and 24) and a drop layer 178 (FIG. 31). Referring first to FIG. 19, the top switch housing layer 172 includes a floor 180 and an outer wall 182 that forms part of the outer casing 164 extending upwardly from the floor 180. The floor 180 has the multiple cartridge ports 110a-f formed therethrough. The cartridge ports 110a-f are shaped to receive the dispensing ends 77 of the cartridges 22 and include a main portion 184 and a flange receiving portion 186 extending outwardly from the wider main portion that receives the flange of the cartridge 22. The flange receiving portion 186 may be narrower than the width of the volume 64 of the cartridge 22. The outer wall 182 includes a series of notches 188 and associated wells 189 formed about its periphery for receiving a portion (e.g., an upper half) of the selector switches 115. The wells 189 are sized to allow actuation of the selector switches 115 between their open and closed configurations. A push rod support 190 extends upwardly from the floor 180 having an opening 192 extending therethrough for receiving the push rod 116. As can be seen, the opening 192 is semi-circular in shape having a flat portion for receiving a similarly shaped portion of the push rod 116. Such a non-circular configuration can prevent turning of the push rod 116 during actuation of the push rod 116, as will be described in greater detail below.

Referring next to FIG. 20, the top switch housing layer 172 may be fixedly connected to the bottom switch housing layer 174 (e.g., see fastener openings 194 in the top switch housing layer 172 which may be aligned with fastener openings 196 in the bottom switch housing layer 174). The bottom switch housing layer 174 may include a floor 198 and an outer wall 200 that forms part of the outer casing 164 extending upwardly from the floor 198. The floor 198 has multiple cartridge receiving areas 202a-f at spaced angularly along the floor 198. In some embodiments, partitioning walls 204 may be provided for at least partly separating adjacent cartridge receiving areas 202a-f. The outer wall 200 includes a series of notches 206 formed about its periphery for receiving a portion (e.g., a bottom half) of the selector switches 115. An opening may also be provided for receiving the push rod 116.

Each cartridge receiving area 202a-f may include a tablet receiving opening 208a-f. The tablet receiving openings 208a-f may generally be aligned with associated cartridge ports 110a-f such that the tablet receiving openings 208a-f may receive tablets 24 dispensed from the cartridges 22 located in the cartridge ports 110a-f. A catch engaging structure 210a-f may be provided adjacent the tablet receiving openings 208a-f. The catch engaging structures 210a-f (e.g., ridges or ramps) may be shaped and arranged to engage the catch structure 78 to move the catch member 84 away from the volume 64 of the respective cartridge (e.g., as the dispensing end 77 of the cartridge 22 is inserted into the cartridge receiving area 202a-f through the cartridge ports 110a-f) such that tablets 24 may be readily dispensed from the cartridge 22.

FIG. 21 illustrates the cartridge 22 inserted into the cartridge receiving area 202 (through the cartridge port 110). As can be seen, the catch engaging structures 210 force the catch structure 78 to an open configuration with the catch member 84 moved away from the volume 64 of the cartridge 22 thereby allowing the tablets 24 to be dispensed from the cartridge 22. In some embodiments, the catch structure 78 is formed of a resilient material and is cantilevered to the cartridge 22 such that upon removal of the cartridge 22 from the cartridge receiving area 202, the catch structure 78 returns back (or is biased toward) its closed position to locate the catch member 84 in its initial, undeflected position thereby inhibiting the dispensing of tablets 24 from the volume 64. While the catch engaging structures 210 are shown, in another embodiment, catch engaging mechanisms may be provided that engage and open and close the catch structure 78, for example, based on an input. In some embodiments, engaging structure may be provided on the cartridge 22 and/or in the tablet dispenser 10 to engage and hold the cartridge 22 once inserted into the cartridge port 110. In some embodiment, the cartridge 22 may snap into place, indicating proper insertion.

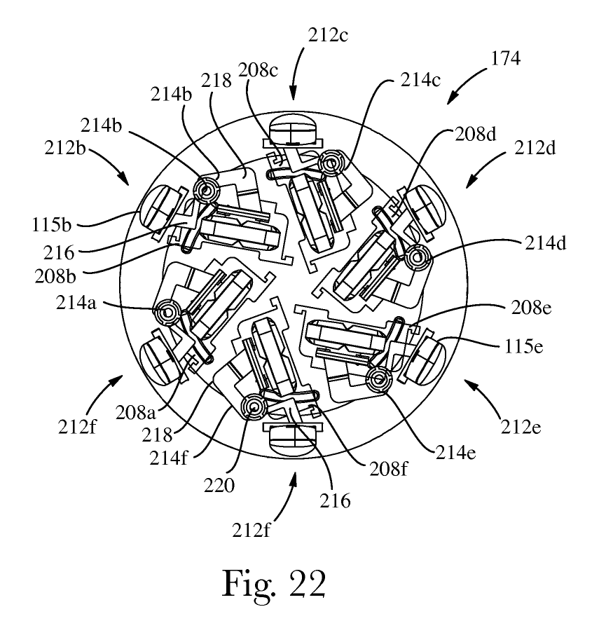

Referring to FIG. 22, in some embodiments, latching mechanisms 212a-f are provided for selectively allowing and for inhibiting passage of the tablets 24 through the tablet receiving openings 208a-f, even when the catch structures 78 of the cartridges 22 are placed in their open configurations. The latching mechanisms 212a-f may include latch plates 214a-f that are operatively connected at one end to the selector switches 115a-f (only selector switches 115b and 115e are illustrated with the other selector switches removed for purposes of explanation). The latch plates 214a-f each include a connector arm 216 that extends toward the associated selector switch 115 and a blocking arm 218 that extends toward the associated tablet receiving opening 208. A pivot 220 is provided between the connector arm 216 and the blocking arm 218 that allows for pivoting movement of the latch plates 214.

Actuation of the selector switches 115a-f pivots their associated latch plates 214a-f between latched and unlatched configurations. As can be seen by FIG. 22, latch plates 214c, 214d and 214e are illustrated in a latched configuration (with the selector switches 115c, 115d and 115e in their closed configurations) where the blocking arms 218 extend into and/or over the tablet receiving openings 208c, 208d and 208e thereby inhibiting passage of the tablets 24 through the tablet receiving openings 208c, 208d and 208e. The latch plates 214a, 214b and 214f are illustrated in an open configuration (when the selector switches 115a, 115b and 115f are in their open configurations) where the blocking arms 218 are removed away from the tablet receiving openings 208a, 208b and 208f thereby allowing passage of the tablets 24 through the tablet receiving openings 208a, 208b and 208f.

Referring to FIG. 23, the carrier layer 176 is moveably connected beneath the bottom switch housing layer 174. The carrier layer 176 includes a top 222 that may face the bottom switch housing layer 174, a bottom 224 that may face the drop layer 178 and a series of tablet carrying chambers 226a-f disposed about a center of the carrier layer 176. Each tablet carrying chamber 226a-f is formed by sidewalls 228 and 230 and end walls 232 and 240 that extend downwardly from the bottom 224. In some embodiments, one or more of the walls 228, 230, 232 and 240 may extend downwardly a distance that is about a width or more of the tablets 24 measured between the sides 38 and 42 of the tablets 24 (see FIG. 3).

Referring to FIG. 24, the carrier layer 176 includes a slot 242 that is shaped to slidably receive a spiral head of the push rod 116. In some embodiments, the slot 242 may be generally located at a geometric center of the carrier layer and include an enlarged portion 244 and narrow portions 246 and 248 extending from opposite sides of the enlarged portion 244. Other configurations are contemplated depending, for example, on the cross-sectional shape of the spiral head of the push rod 116.

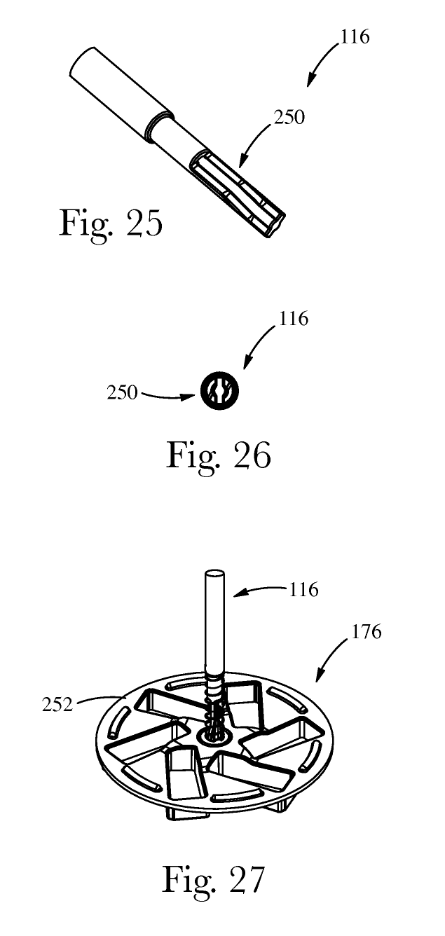

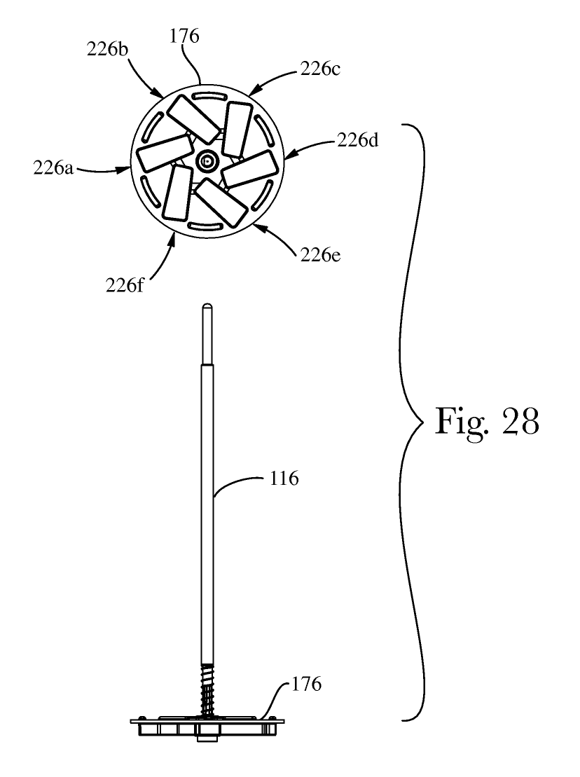

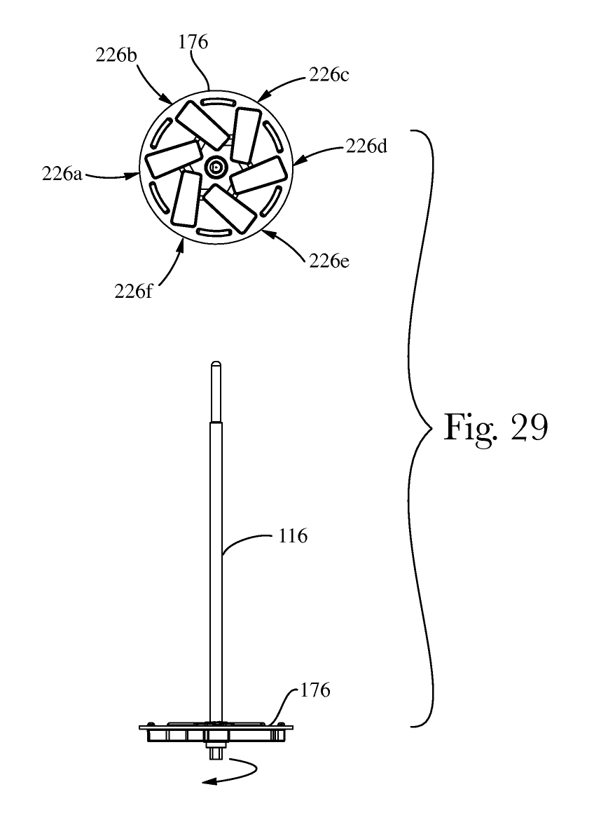

FIGS. 25 and 26 show a partial view of the push rod 116 including the spiral head 250. FIG. 27 illustrates the push rod 116 with the spiral head 250 inserted into the slot 242. In some embodiments, a biasing mechanism, such as spring 252 may be provided, which biases the push rod 116 toward its undeflected position. Referring to FIGS. 28 and 29, the push rod 116 is illustrated rotating the carrier layer 176 with FIG. 28 showing the push rod 116 and carrier layer 176 in their initial, unactuated positions and FIG. 29 shows the push rod 116 and the carrier layer 176 in their actuated positions where the spiral head 250 of the push rod 116 is pushed through the slot 242 (e.g., using button 120) thereby causing the carrier layer 176 to rotate. In some embodiments, the carrier layer 176 may rotate about 30 degrees in its actuated position.

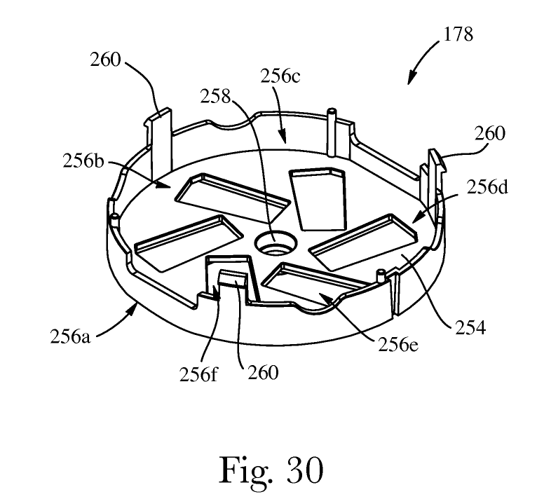

Referring to FIG. 30, the drop layer 178 may be fixedly connected beneath the carrier layer 176 such that the carrier layer 176 can rotate relative to the top switch housing layer 172, bottom switch housing layer 174 and the drop layer 178. The drop layer 178 may include a floor 254 having a series of tablet receiving openings 256a-f formed therethrough. An alignment opening 258 is provided at about the geometric center of the drop layer 178 which can be used to connect and align the drop layer 178 with the rest of the components of the dispensing mechanism 118. Connecting structures 260 (e.g., clips) or alternately an adhesive or welding type processes may be used for fixedly connecting the drop layer 178 to the bottom of the bottom switch housing layer 174, leaving a gap between the floor 198 of the bottom switch housing layer 174 and the floor 254 of the drop layer 178 in which the carrier layer 176 is located.

Referring to FIGS. 31-33A, operation of the dispensing mechanism 118 will be explained. In FIGS. 32-34A, the dispensing mechanism 118 is illustrated with the top switch housing layer 172 and the latching mechanisms 212 removed for clarity. As can be seen most clearly by FIGS. 31A, 32A and 33A, the dispensing mechanism 118 may include the bottom switch housing layer 174, the drop layer 178 and the carrier layer 176 located within the gap 262 between the floor 198 of the bottom switch housing layer 174 and the floor 254 of the drop layer 178. The bottom switch housing layer 174 and the drop layer 178 are fixedly connected to each other, while the carrier layer 176 may rotate within the gap 262, as described above.

In the initial, unactuated position, the tablet carrying chambers 226a-f of the carrier layer are out-of-alignment (i.e., out-of-phase) with the tablet receiving openings 208a-f of the bottom switch housing layer 174. In some embodiments, the tablet carrying chambers 226a-f may be aligned (i.e., in phase) with the tablet receiving openings 256a-f of the drop layer 178 in the initial, unactuated position. As can be seen by FIGS. 31 and 31A, the tablet 24 is prevented from passing through the tablet receiving openings 208a-f of the bottom switch housing layer 174 when the tablet carrying chambers 226a-f of the carrier layer 176 are out-of-alignment with the tablet receiving openings 208a-f of the bottom switch housing layer 174. Referring to FIGS. 32 and 32A, actuation of the button 120 deflects the push rod 116, which rotates the carrier layer 176 (e.g., 30 degrees) thereby aligning the tablet carrying chambers 226a-f with the tablet receiving openings 208a-f of the bottom switch housing layer 174. As can be seen by FIG. 32A, the tablets 24 (depending on whether the associated latch mechanism 212 is in the open configuration) may then pass (e.g., under the influence of gravity) from the bottom switch housing layer 174 into the tablet carrying chambers 226a-f. In the illustrated embodiment, the tablets 24 may be maintained on their side as they pass between the layers of the dispensing mechanism 118, however, other arrangements are contemplated. Referring to FIGS. 33 and 33A, once the button 120 is released, the push rod 116 may return to its initial, undeflected position (e.g., due to the bias force applied to the push rod 116), which rotates carrier layer 176 back to its initial position where the tablet carrying chambers 226a-f are again aligned with the tablet receiving openings 256a-f of the drop layer 178. As the carrier layer 176 rotates, the tablets 24 are carried within the tablet carrying chambers 226a-f from beneath the tablet receiving openings 208a-f of the bottom switch housing layer 174 to the tablet receiving openings 256a-f of the drop layer 178 where the tablets 24 may pass from the tablet carrying chambers 226a-f through the tablet receiving openings 256a-f (e.g., under the force of gravity). It should be noted that while FIGS. 19-33A illustrate one exemplary dispensing mechanism embodiment including three or more layers, it should be noted that more or less layers may be employed. Another exemplary embodiment including less than three layers, for example, will be described below.

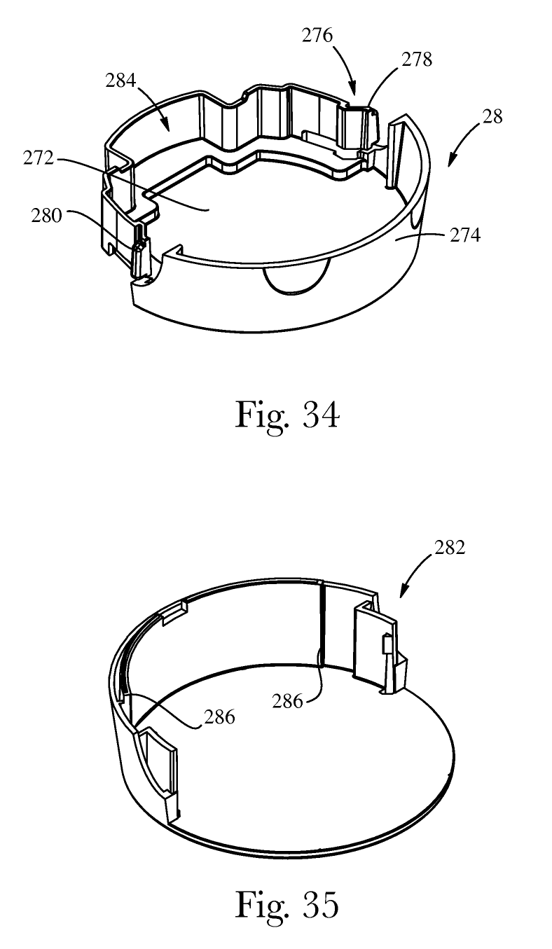

A drawer or removable container assembly may be connected to or part of the main housing 14 (FIG. 1) and may include the container 28 into which the tablets 24 are dispensed. FIG. 34 shows one embodiment of the container 28 that is removable from a drawer receiving opening of the removable container assembly 270. The container 28 may include a bottom 272 and a sidewall 274 extending upwardly from the floor. A latch feature 276 may be provided including deflectable latches 278 and 280, which may latch with a mating latch feature of the removable container assembly 270 for inhibiting unintended removal of the container 28 from the removable container assembly 270. In some embodiments, the container 28 may be biased toward its open position such that when unlatched the container 28 ejects outwardly. FIG. 35 illustrates a removable lid 282 that can releasably fasten to the container 28 for closing an opening 284 of the container 28. The lid may include a snap feature 286 for interlocking with the latch feature 276 of the container 28. Any other suitable connecting features may be utilized, such as threads. Providing the lid 282 can increase portability of the container 28 and allow a consumer to carry the tablets 24 once they are dispensed.

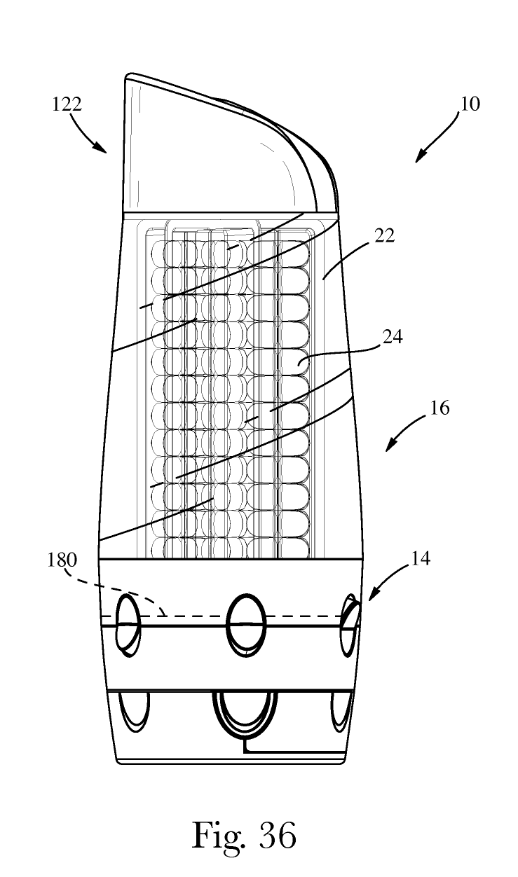

Referring now to FIG. 36, the above-described tablet dispenser 10, associated cartridges 22 and tablets 24 may provide a convenient, portable system and process for selectively dispensing a plurality of tablets 24 (same or different tablets) simultaneously from one or multiple cartridges 22. The dispensing ends 77 of the cartridges 22 may be received within the cartridge ports 110 such that the cartridges 22 extend vertically above the floor (represented by dotted line 180) of the top switch housing layer 172. In some embodiments, about 33 percent or less of the cartridge 22 is received by the cartridge ports 110 and below the floor 180 of the top switch housing layer 172. In some embodiments no less than about 50 percent of the cartridge is exposed above the floor 180 of the top switch housing layer 172 and above main housing. In some embodiments, at least about 25 percent of the cartridge 22 is located above the main housing 14 and below the top (or button receiving housing 122) of the cartridge receiving housing 16.

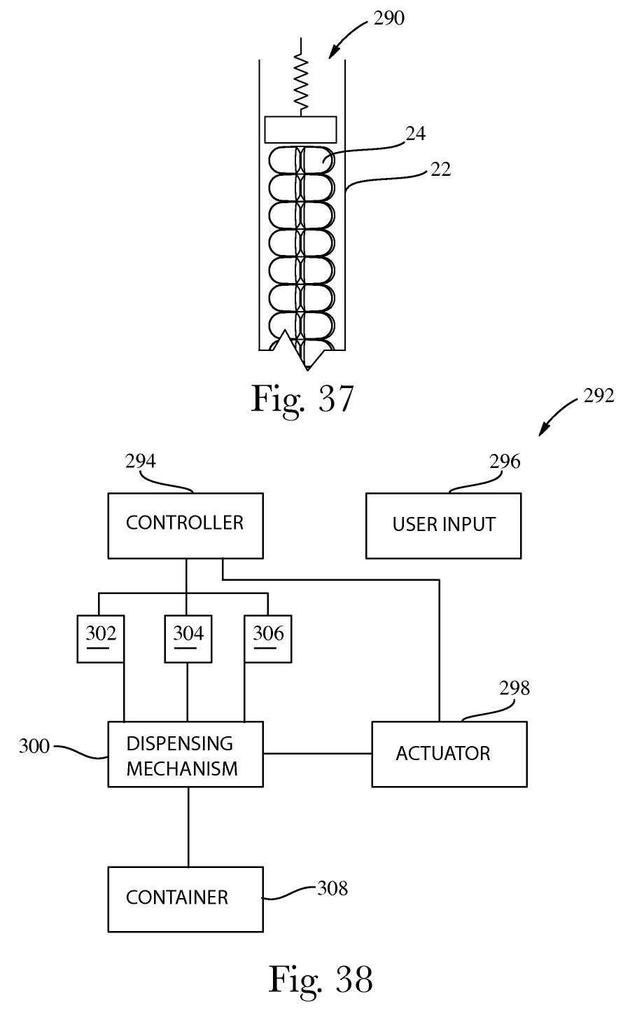

In some embodiments, the tablets 24 may be gravity fed through the tablet dispenser 10. In such embodiments, it may be desirable to provide a relatively low coefficient of friction between the tablets 24 and the cartridges 22 as the tablets 24 slide along the guide rails 86, 88 of the cartridges 22. In some embodiments, the frictional force between the tablet 24 and the cartridge 22 may be less than the force due to gravity on the tablet 24 so that gravity exerts a greater force than the force of friction of the tablet 24 thereby allowing the tablet 24 to slide through the cartridge 22 and be dispensed under the force of gravity. In some embodiments, the frictional force may be less than about 80 percent of the force of gravity, for example, so that the tablet 24 may drop through the cartridge at a suitable or preselected rate. The friction force between the tablet 24 and the cartridge 222 may be lowered, for example, using any suitable glidant coating applied to the tablet 24 and/or the cartridge 22. In some embodiments, a glidant coating may be applied to the tablet 24 and/or the cartridge 22 to provide a relatively even distribution of friction forces at opposite ends of the tablet 24 as the tablet 24 slides through the cartridge 22 to minimize or reduce rotational forces on the tablet 24 as it drops through the cartridge 22. In some embodiments, the tablets 24 may be pushed (or otherwise moved) through the cartridges 22 by another applied force. For example, FIG. 37 illustrates an embodiment where the tablets 24 are fed through the cartridges 22 using an actuator such as a spring based actuator 290. Other actuator types may be utilized.

Referring to FIG. 38, in another illustrative embodiment, a tablet dispenser 292 may be driven automatically, for example, using a controller 294, a user input 296, one or more actuators 298 and a dispensing mechanism 300. For example, based on a user input, the controller 294 may open (or close) one or more of latching mechanisms 302, 304 and 306 to allow one or more tablets 24 to be dispensed from cartridges. The actuator 298 may then operate the dispensing mechanism 300, which dispenses the selected tablets into a container 308.

In some embodiments, the tablet dispensers may include a power source, such as a battery, and/or may be connected to a power source. The tablet dispensers may be programmed to provide reminders, e.g., when and/or which tablets 24 to take and/or whether tablets 24 have already been taken and include memory to storing such tablet information. The tablet dispensers may include a display, for example, displaying the time and/or tablet information, alarms, etc. While tablets 24 are primarily discussed above, other pill-types may be used with the tablet dispensers, such as capsules. The tablets 24 may or may not have grooves. In some embodiments, the tablet dispensers may receive information from a user and/or retrieve information automatically from a network or Internet connection. In some embodiments, a system of multiple tablet dispensers may be utilized, e.g., for various members of a household and the tablet dispensers may be able to communicate tablet information and/or other data between tablet dispensers, e.g., through a wired or wireless connection.

The tablet dispenser 10 or any component thereof, may be transparent, opaque, or of any other appearance. In some embodiments, it may be desirable that at least one component of the tablet dispenser 10 is transparent to some extent. For example, wherein tablets 24 housed within a given cartridge 22 are of a certain color to associate a functional benefit as described herein above, and the cartridge 22 housing such tablets are to some extent of transparent, it may also be desirable that certain portions of the tablet dispenser 10 (for example, upper housing 16) are to some extent transparent such that the user can see the color of the tablets prior to dispensing, thereby aiding a dispensing decision. It is well within the skills of the ordinary artisan to design and manufacture tablet dispensers 10 having the desired appearance.

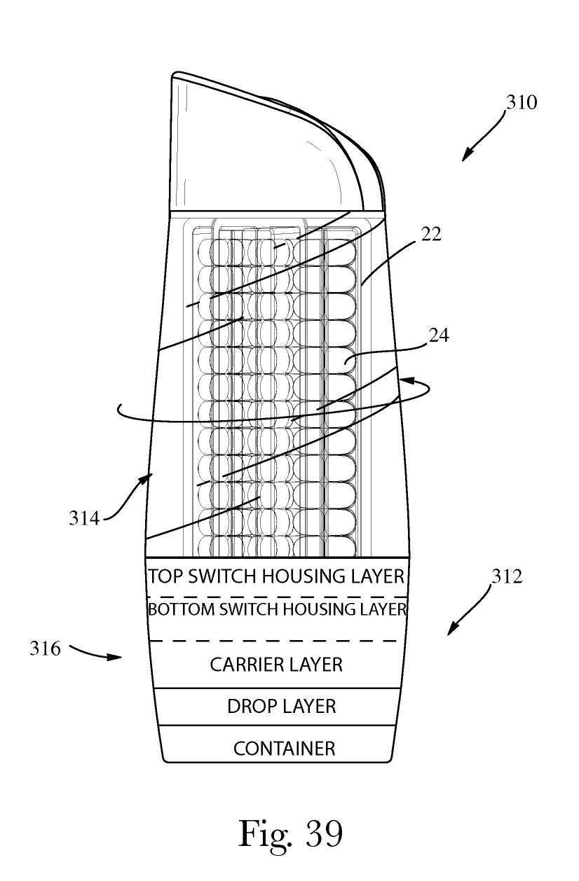

Referring to FIG. 39, in another illustrative embodiment, a tablet dispenser 310 may include a dispensing mechanism 312 having less than three layers. In the embodiment of FIG. 39, a cartridge receiving housing 314 may, itself, provide a carrier layer 316. For example, the cartridge receiving housing 314 may include structure similar to the top switch housing 172, the bottom switch housing layer 174, the latching mechanisms 212 and the carrier layer 176 described above with the tablet carrying chambers 226a-f fixedly aligned with the tablet receiving openings 208a-f of the bottom switch housing layer 174. In this embodiment, for example, the cartridge receiving housing 314 including cartridges 22 may rotate to align the tablet carrying chambers with the tablet receiving openings in the drop layer.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. An ingestible tablet, comprising:
a front face;
a rear face;
sides that extend about a periphery of the front and rear faces; and
a groove extending along at least one of the front and rear faces, the groove intersecting the periphery at opposite sides and being sized to receive a guide rail of a cartridge for inhibiting rotational movement and maintaining alignment of the ingestible tablet as the ingestible tablet is fed through the cartridge.

2. The ingestible tablet of claim 1 further comprising a glidant coating, wherein the groove has the glidant coating located therein thereby forming a recessed, low friction surface arranged to contact the guide rail of the cartridge.

3. The ingestible tablet of claim 2, wherein the groove is V-shaped in cross-section.

4. The ingestible tablet of claim 2, wherein the groove is a first groove that extends along the front face and the guide rail is a first guide rail of the cartridge, the tablet further comprising a second groove that extends along the rear face, intersecting the periphery at the opposite sides and being sized to receive a second guide rail of the cartridge for inhibiting rotational movement and maintaining alignment of the ingestible tablet as the ingestible tablet is fed through the cartridge.

5. The ingestible tablet of claim 4, wherein the second groove has the glidant coating located therein thereby forming a recessed, low friction surface arranged to contact the second guide rail of the cartridge.

6. The ingestible tablet of claim 5, wherein the ingestible tablet having a maximum thickness at a location spaced from the first and/or second groove and a minimum thickness at the first and/or second groove, wherein the minimum thickness is no greater than about 95 percent of the maximum thickness.

7. The ingestible tablet of claim 6, wherein the minimum thickness is no less than about 50 percent of the maximum thickness.

8. The ingestible tablet of claim 2, wherein a ratio of a width of the groove to a depth of the groove is no greater than about 2.5.

9. For a tablet dispenser, a cartridge for holding a plurality of ingestible tablets, the cartridge comprising:
a front wall;
a rear wall;
side walls extending from the front wall to the rear wall, the front wall, rear wall and sidewalls defining a volume for receiving the plurality of ingestible tablets such that the plurality of ingestible tablets may be fed from the volume; and
a guide rail extending into the volume along a height of the front wall or the rear wall, the guide rail sized and arranged to slidably engage the plurality of ingestible tablets for inhibiting rotational movement and maintaining alignment of the plurality of ingestible tablets as the plurality of ingestible tablets are fed through the volume.

10. The cartridge of claim 9, wherein the plurality of ingestible tablets are received in the volume in a side-by-side fashion.

11. The cartridge of claim 9, wherein the guide rail is sized and arranged to slidably engage the plurality of ingestible tablets for inhibiting rotational movement and maintaining alignment of the plurality of ingestible tablets as the plurality of ingestible tablets are gravity fed through the volume.

12. The cartridge of claim 9, wherein the guide rail is sized and arranged to slidably engage the plurality of ingestible tablets for inhibiting rotational movement and maintaining alignment of the plurality of ingestible tablets as the plurality of ingestible tablets are pushed through the volume by an actuator.

13. The cartridge of claim 9 further comprising an ingestible tablet located in the volume, the ingestible tablet comprising
a front face;
a rear face;
sides that extend about a periphery of the front and rear faces; and
a groove extending along at least one of the front and rear faces, the groove intersecting the periphery at opposite sides and receiving the guide rail of the cartridge for inhibiting rotational movement and maintaining alignment of the ingestible tablet as the ingestible tablet is gravity fed through the cartridge.

14. The cartridge of claim 13, wherein the groove is a first groove that extends along the front face and the guide rail is a first guide rail extending along the height of the front wall of the cartridge, the tablet further comprising a second groove that extends along the rear face, intersecting the periphery at the opposite sides and receiving a second guide rail extending along a height of the rear wall of the cartridge for inhibiting rotational movement and maintaining alignment of the ingestible tablet as the ingestible tablet is gravity fed through the cartridge.

15. The cartridge of claim 14, wherein the ingestible tablet has a maximum thickness at a location spaced from the first and/or second groove and a minimum thickness at the first and/or second groove, wherein the minimum thickness is no less than about 50 percent of a distance between the rear wall and the front wall of the cartridge.

16. The cartridge of claim 9, wherein at least one or more of the front wall, rear wall and side walls are formed of a transparent material such that the plurality of ingestible tablets can be seen from outside the cartridge.

17. A portable tablet dispenser, comprising:
a cartridge defining a volume for receiving a plurality of ingestible tablets, the cartridge including a dispensing end through which the plurality of ingestible tablets are dispensed from the volume and a catch mechanism having a closed configuration that inhibits dispensing of the plurality of ingestible tablets from the volume and an open configuration that allows dispensing of the plurality of ingestible tablets from the volume; and
a main housing including a cartridge port that receives the dispensing end of the cartridge, the main housing including a catch engaging structure arranged and configured to engage the catch mechanism of the cartridge for moving the catch mechanism from the closed configuration to the open configuration.

18. The portable tablet dispenser of claim 17, wherein the cartridge port receiving about 33 percent or less of the cartridge.

19. The portable tablet dispenser of claim 17, wherein no less than about 50 percent of the cartridge is exposed above the main housing.

20. The portable tablet dispenser of claim 17, wherein the cartridge is formed of a transparent material such that the plurality of ingestible tablets are observable outside the cartridge.

21. The portable tablet dispenser of claim 17, wherein the cartridge comprises a front and a back, the front and back being joined at a flange extending away from the volume.

22. The portable tablet dispenser of claim 21, wherein the cartridge port includes a main portion and a flange receiving opening that receives the flange of the cartridge.

23. The portable tablet dispenser of claim 22, wherein the flange receiving opening has a width that is less than a width of the volume.

24. The portable tablet dispenser of claim 17 further comprising a cartridge receiving housing including a top and a sidewall extending downwardly to the main housing.

25. The portable tablet dispenser of claim 24, wherein at least 25 percent of the cartridge being located above the main housing and below the top of the cartridge receiving housing.

26. The portable tablet dispenser of claim 24, wherein one or more of the ingestible tablets are observable within a portion of the cartridge located above the main housing and below the top of the cartridge receiving housing from outside the sidewall of the cartridge receiving housing.

27. The portable tablet dispenser of claim 17, wherein the catch engaging structure is configured to engage the catch mechanism of the cartridge for moving the catch mechanism between the closed configuration and the open configuration.

28. A portable tablet dispenser, comprising:
a carrier layer including a tablet carrying chamber sized to receive an ingestible tablet; and
a drop layer located beneath the carrier layer and including a tablet receiving opening through which the tablet may pass from the tablet carrying chamber;
wherein, in a rest configuration, the tablet carrying chamber is in alignment with the tablet receiving opening;
wherein, in a triggered configuration, the tablet carrying chamber is moved out of alignment with the tablet receiving opening.

29. The portable tablet dispenser of claim 28, wherein the tablet receiving opening is a first tablet receiving opening, the portable tablet dispenser further including a bottom switch housing layer including a second tablet receiving opening through which the tablet may pass into the tablet receiving chamber, wherein in the rest configuration the tablet receiving chamber being out of alignment with the second tablet receiving opening.

30. The portable tablet dispenser of claim 28, wherein the bottom switch housing layer includes a latch mechanism having a closed configuration that inhibits passing of the tablet through the second tablet receiving opening and an open configuration that allows passing of the tablet through the second tablet receiving opening.

31. A portable tablet dispenser, comprising:
a plurality of cartridges including a first cartridge including a first plurality of ingestible tablets housed therein and a second cartridge including a second plurality of ingestible tablets housed therein;
a main housing including a first cartridge port that receives a dispensing end of the first cartridge and a second cartridge port that receives a dispensing end of the second cartridge; and
a dispensing mechanism located in the main housing, the dispensing mechanism configured to selectively dispense an individual ingestible tablet from one and simultaneously both of the first cartridge and the second cartridge where selection is based on a user input.

32. The portable tablet dispenser of claim 31, wherein the first cartridge includes a catch mechanism having a closed configuration that inhibits dispensing of the plurality of ingestible tablets from the volume and an open configuration that allows dispensing of the plurality of ingestible tablets from the volume.

33. The portable tablet dispenser of claim 32, wherein the main housing includes a catch engaging structure arranged and configured to engage the catch mechanism of the first cartridge for moving the catch mechanism from the closed configuration to the open configuration.

34. The portable tablet dispenser of claim 31 further comprising a third cartridge including a third plurality of ingestible tablets housed therein, the main housing including a third cartridge port that receives a dispensing end of the third cartridge.
